(19) United States
(12) Patent Application Publication
(10) Pub. No.: US 2017/0158782 A1
(43) Pub. Date: Jun. 8, 2017

(54) RUBBER COMPOSITION

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Etienne FLEURY, Clermont-Ferrand Cedex 9 (FR); Julien THUILLIEZ, Clermont-Ferrand Cedex 9 (FR); Jean-Michel FAVROT, Clermont-Ferrand Cedex 9 (FR)

(21) Appl. No.: 15/327,176

(22) PCT Filed: Jul. 9, 2015
(86) PCT No.: PCT/EP2015/065753

§ 371 Date: Jan. 18, 2017

(30) Foreign Application Priority Data
Jul. 21, 2014 (FR) 1457013

(51) Int. Cl. C08C 19/22; B60C 1/00; C08J 3/20; C08J 3/24; C08K 3/36; C08K 3/04

(52) U.S. Cl. CPC C08C 19/22; C08K 3/36; C08K 3/04; C08J 3/203; C08J 3/24; B60C 1/0016; C08J 2309/00; C08J 2309/06

(57) ABSTRACT

The present invention relates to a rubber composition based on at least one diene elastomer, a reinforcing filler, a chemical crosslinking agent, and a modifying agent, optionally already grafted to the diene elastomer, the modifying agent comprising an associative group and a dipole, the diene elastomer before grafting the modifying agent comprising the units UA, UB, UC and UD, randomly distributed according to a respective molar percentage m, n, o and p.

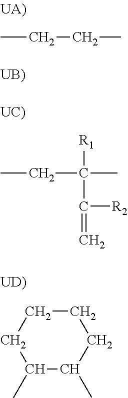

R₁ and R₂, which are identical or different, denoting a hydrogen atom, a methyl radical or a phenyl radical substituted or unsubstituted in the ortho, meta or para position by a methyl radical, m≧50 0<o+p≦25, n+o>0, m, n, o and p being numbers ranging from 0 to 100.

This application is a 371 national phase entry of PCT/EP2015/065753, filed 9 Jul. 2015, which claims benefit of French Patent Application No. 1457013, filed 21 Jul. 2014, the entire contents of which are incorporated herein by reference for all purposes.

### BACKGROUND

1. Technical Field

The present invention relates to a diene rubber composition reinforced by a filler and which may be used especially in the manufacture of tires for vehicles. It relates more particularly to tire treads having a low rolling resistance.

2. Related Art

Since savings in fuel and the need to protect the environment have become a priority, it is desirable to produce mixtures having good wear resistance properties while having a hysteresis which is as low as possible in order to be able to process them in the form of rubber compositions which can be used in the manufacture of various semi-finished products involved in the composition of tires, such as for example treads, in order to obtain tires having an improved wear resistance without adversely affecting the rolling resistance.

Ideally, for example, a tire tread must fulfil a great many technical requirements, which are often contradictory in nature, including increased wear resistance while affording the tire low rolling resistance and enhanced grip, both on dry ground and on wet, snowy or icy ground.

It is known that to improve wear resistance a certain stiffness of the tread is desirable, which stiffening of the tread may be obtained for example by increasing the content of reinforcing filler in the rubber compositions making up these treads. Unfortunately, experience shows that such stiffening of the tread adversely affects the rolling resistance properties, in a known way and often prohibitively so, since it is accompanied by significantly increased hysteresis losses of the rubber composition. Consequently, improving the stiffness performance while maintaining low rolling resistance is a constant concern of tire designers.

There is therefore a permanent need to provide a rubber composition which enables tires with an improved performance compromise between wear resistance and rolling resistance to be obtained.

### SUMMARY

In light of the above, it is a general aim to provide rubber compositions for tires which satisfy an improved compromise in properties between stiffness and hysteresis for use in tires, especially in treads.

The Applicants have discovered that the combined use of a specific diene elastomer and a modifying agent in a rubber composition makes it possible to provide a rubber composition bringing together both a very high level of stiffness and a very low level of hysteresis.

Thus, a first subject of the invention is a rubber composition based on at least one first diene elastomer, a reinforcing filler, a chemical crosslinking agent, and a modifying agent, optionally already grafted to the first diene elastomer, the modifying agent comprising a group Q and a group A connected to one another by a group B in which:
Q comprises a dipole containing at least and preferably one nitrogen atom,
A comprises an associative group comprising at least one nitrogen atom,
B is an atom or a group of atoms forming a bond between Q and A,
characterized in that the first diene elastomer before grafting the modifying agent comprises the following units UA, UB, UC and UD, randomly distributed within the first diene elastomer,

UA) —CH₂—CH₂— according to a molar percentage of m %

UB) according to a molar percentage of n %

UC)

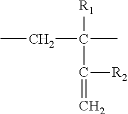

according to a molar percentage of o %

UD)

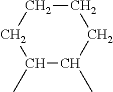

according to a molar percentage of p %
R₁ and R₂, which are identical or different, denoting a hydrogen atom, a methyl radical or a phenyl radical which is unsubstituted or substituted in the ortho, meta or para position by a methyl radical
m≧50
0<o+p≦25
n+o>0
m, n, o and p being numbers ranging from 0 to 100
the respective molar percentages of m, n, o and p being calculated on the basis of the sum of m+n+o+p, which is equal to 100.

Another subject of the invention is a first process for preparing the composition in accordance with embodiments of the invention, which process comprises the following steps:
modifying the first diene elastomer in post-polymerization or in solution or in bulk by grafting the modifying agent,
Incorporating, to the first diene elastomer grafted in this way by the modifying agent, the reinforcing filler and all the base constituents of the composition, with the exception of the chemical crosslinking agent, by thermomechanically kneading everything, once or several times, until a maximum temperature of between 130° C. and 200° C. is achieved,
cooling the combined mixture to a temperature of less than 100° C.,
then incorporating the chemical crosslinking agent,
kneading everything up to a maximum temperature of less than 120° C.

Another subject of the invention is a second process for preparing the composition in accordance with embodiments of the invention, which process comprises the following steps:
Incorporating, during the mixing, the first diene elastomer, the modifying agent, and preferably subsequently the reinforcing filler and all the base constituents of the composition, with the exception of the chemical crosslinking agent, by thermomechanically kneading everything, once or several times, until a maximum temperature of between 130° C. and 200° C. is achieved,
cooling the combined mixture to a temperature of less than 100° C.,
then incorporating the chemical crosslinking agent,
kneading everything up to a maximum temperature of less than 120° C.

Another subject of the invention is a semi-finished product made of rubber, especially a tire tread, which semi-finished product comprises the rubber composition in accordance with embodiments of the invention.

Yet another subject of the invention is a tire comprising the semi-finished product in accordance with embodiments of the invention, especially the tread in accordance with embodiments of the invention.

### I. DETAILED DESCRIPTION OF EXAMPLE EMBODIMENTS

In the present description, unless expressly indicated otherwise, all the percentages (%) shown are % by weight. The abbreviation “phr” means parts by weight per hundred parts of elastomer (of the total of the elastomers, if several elastomers are present).

Furthermore, any interval of values denoted by the expression “between a and b” represents the range of values greater than “a” and lower than “b” (that is to say, limits a and b excluded), whereas any interval of values denoted by the expression “from a to b” means the range of values extending from “a” up to “b” (that is to say, including the strict limits a and b).

The expression “composition based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tires) being capable of reacting or intended to react with one another, at least in part, during the various phases of manufacture of the composition intended for the manufacture of tires.

The rubber composition is based on at least one first diene elastomer and a modifying agent. The first diene elastomer may be grafted by the modifying agent prior to the introduction thereof into the rubber composition, or else may be grafted by reaction with the modifying agent during the manufacture of the composition.

In the present patent application, the term “the first diene elastomer” refers to the elastomer before the reaction thereof for grafting with the modifying agent.

The first diene elastomer, that is to say, by definition, before the reaction for grafting the modifying agent, comprises the following units UA, UB, UC and UD, which units UA, UB, UC and UD are randomly distributed within the first diene elastomer,

UA) —CH₂—CH₂— according to a molar percentage of m %

UB) according to a molar percentage of n %

UC)

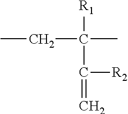

according to a molar percentage of o %

UD)

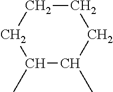

according to a molar percentage of p %
R₁ and R₂, which are identical or different, denoting a hydrogen atom, a methyl radical or a phenyl radical which is unsubstituted or substituted in the ortho, meta or para position by a methyl radical
m≧50
0<o+p≦25
n+o>0
m, n, o and p being numbers ranging from 0 to 100
the respective molar percentages of m, n, o and p being calculated on the basis of the sum of m+n+o+p, which is equal to 100.

According to a specific embodiment of the invention, the first diene elastomer contains units UE distributed randomly within the first diene elastomer:

UE)

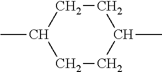

according to a molar percentage of q %
o+p+q≧10
q≧0
the respective molar percentages of m, n, o, p and q being calculated on the basis of the sum of m+n+o+p+q, which is equal to 100.

Whereas the subunit of the unit UD forms a divalent hydrocarbon ring comprising 6 carbon atoms of 1,2-cyclohexane type, the subunit of the unit UE forms a divalent hydrocarbon ring comprising 6 carbon atoms of 1,4-cyclohexane type.

According to another specific embodiment of the invention, the first diene elastomer contains units UF distributed randomly within the first diene elastomer:

UF)

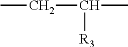

according to a molar percentage of r %
R₃ denoting an alkyl radical having from 1 to 4 carbon atoms or an aryl radical,
0≦r≦25, preferably 0≦r≦10,
the respective molar percentages of m, n, o, p and r being calculated on the basis of the sum of m+n+o+p+r, which is equal to 100.

According to this specific embodiment of the invention, the first diene elastomer can comprise q % of units UE distributed randomly within the first diene elastomer, in which case the respective molar percentages of m, n, o, p, q and r are calculated on the basis of the sum of m+n+o+p+q+r, which is equal to 100.

It is understood that the first diene elastomer can consist of a mixture of elastomers which comprise the units UA, UB, UC, UD, UE and UF and which differ from one another in their macrostructure or their microstructure, in particular in the respective content of their units.

According to any one of the embodiments of the invention, the first diene elastomer preferably does not contain a unit UF.

According to any one of the embodiments of the invention, at least one of the two molar percentages p and q is preferably different from 0. In other words, the first diene elastomer preferably contains at least one of the subunits which are a divalent hydrocarbon ring comprising 6 carbon atoms of 1,2-cyclohexane type and a divalent hydrocarbon ring comprising 6 carbon atoms of 1,4-cyclohexane type.

According to any one of the embodiments of the invention, p is more preferentially strictly greater than 0.

According to a preferential embodiment of the invention, the first diene elastomer contains, as monomer units, only the units UA, UB, UC, UD and UE according to their respective molar percentage m, n, o, p and q, preferably all different from 0.

According to another preferential embodiment of the invention, the first diene elastomer contains, as monomer units, only the units UA, UB, UC and UD according to their respective molar percentage m, n, o and p, preferably all different from 0.

According to any one of the embodiments of the invention, the units UB present in the first diene elastomer preferably have the trans configuration represented by the following formula:

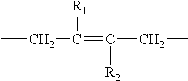

According to any one of the embodiments of the invention, the first diene elastomer preferably has a number-average molar mass (Mn) of at least 60 000 g/mol and of at most 1 500 000 g/mol. The polydispersity index PI, equal to M_{w}/Mₙ (M_{w} being the weight-average molar mass), is preferably between 1.20 and 3.00. This preferred embodiment of the invention applies to any one of the embodiments of the invention. The Mn, Mw and PI values are measured according to the method described in section II.1.

The first diene elastomer can be obtained according to different methods of synthesis known to those skilled in the art, especially as a function of the targeted values of m, n, o, p, q and r. Generally, the first diene elastomer can be prepared by copolymerization of at least one conjugated diene monomer and of ethylene and according to known methods of synthesis, in particular in the presence of a catalytic system comprising a metallocene complex. In this connection, mention may be made of the catalytic systems based on metallocene complexes, which catalytic systems are described in the documents EP 1 092 731 A1, EP 1 554 321 A1, EP 1 656 400 A1, EP 1 829 901 A1, EP 1 954 705 A1 and EP 1 957 506 A1 on behalf of the Applicants.

A conjugated diene having from 4 to 12 carbon atoms is suitable in particular as conjugated diene monomer. Mention may be made of 1,3-butadiene, 2-methyl-1,3-butadiene, 2,3-dimethyl-1,3-butadiene, an aryl-1,3-butadiene or 1,3-pentadiene. According to a preferential aspect, the diene monomer is 1,3-butadiene or 2-methyl-1,3-butadiene, more preferentially 1,3-butadiene, in which case R1 and R2 each represent a hydrogen.

Thus, according to some of these methods of synthesis, the first diene elastomer can be obtained by copolymerization of at least one conjugated diene monomer and of ethylene, in the presence of a catalytic system comprising a lanthanide metallocene complex with ansa ligands of fluorenyl type. In this connection, mention may be made of the metallocene complexes described in the documents EP 1 092 731 A1, EP 1 554 321 A1 and EP 1 954 705 A1.

The first diene elastomer which contains UF units according to a specific embodiment of the invention can be obtained by copolymerization of at least one conjugated diene monomer and of two olefins, such as ethylene and an α-olefin, in the presence of a catalytic system comprising a lanthanide metallocene complex with ligands of ansa cyclopentadienyl-fluorenyl type. For example, an a-olefin having from 3 to 18 carbon atoms, advantageously having from 3 to 6 carbon atoms, is suitable as α-olefin monomer. Mention may be made of propylene, butene, pentene, hexene or a mixture of these compounds. Mention may also be made, as termonomer used in combination with at least one conjugated diene monomer and ethylene, of a styrene derivative. The catalytic systems based on metallocene complexes can be those described in the documents EP 1 092 731 A1, EP 1 656 400 A1, EP 1 829 901 A1 and EP 1 957 506 A1 on behalf of the Applicants.

The first diene elastomer can be prepared in accordance with the abovementioned documents by adjusting the polymerization conditions by means known to those skilled in the art, so as to achieve number-average molar mass (Mn) values of at least 60 000 g/mol. By way of illustration, the polymerization time may be significantly increased so that the monomer conversion is greater, thereby leading to molar masses of at least 60 000 g/mol being obtained. By way of illustration, during the preparation of the catalytic systems according to the abovementioned documents, the stoichiometry of the alkylating agent with respect to the metallocene complex(es) is reduced, so as to reduce chain transfer reactions and to make it possible to obtain molar masses of at least 60 000 g/mol.

In addition to the first diene elastomer, the rubber composition may also comprise a second diene elastomer. The content of the first diene elastomer preferably is at least 50 phr.

According to any one of the embodiments of the invention, the content of the first diene elastomer is preferably at least 70 phr, more preferentially at least 90 phr.

The second diene elastomer may be any homopolymer obtained by polymerization of a conjugated diene monomer having from 4 to 12 carbon atoms, or any copolymer obtained by copolymerization of one or more conjugated dienes with one another or with one or more vinylaromatic compounds having from 8 to 20 carbon atoms. In the latter case, the copolymer contains from 20% to 99% by weight of diene units and from 1% to 80% by weight of vinylaromatic units. By way of conjugated dienes, the following are especially suitable: 1,3-butadiene, 2-methyl-1,3-butadiene, 2,3-di(C1-05 alkyl)-1,3-butadienes such as for example 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene, 2,4-hexadiene. By way of vinylaromatic compounds, the following are for example suitable: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The second diene elastomer may have any microstructure. It may be a block, random, sequential or microsequential elastomer, and may be prepared in emulsion or in solution. It may be coupled and/or star-branched, or else functionalized with a coupling and/or star-branching or functionalizing agent.

The second diene elastomer is preferentially selected from the group of highly saturated diene elastomers (namely comprising at least 50% by weight of units of diene origin which comprise a carbon-carbon double bond), consisting of polybutadienes (BR), polyisoprenes, butadiene copolymers, isoprene copolymers and mixtures thereof. The polyisoprenes can be synthetic polyisoprenes (IR) or natural rubber (NR). It is understood that the second diene elastomer can consist of a mixture of diene elastomers which differ from one another in their microstructure, in their macrostructure, in the presence of a functional group or in the nature or the position of the latter on the elastomer chain.

The modifying agent comprises a (one or more) group Q and a (one or more) group A connected to one another by a group B in which:
Q comprises a dipole containing at least and preferably one nitrogen atom,
A comprises an associative group comprising at least one nitrogen atom,
B is an atom or a group of atoms forming a bond between Q and A.

According to a preferential embodiment of the invention, the modifying agent preferably contains just one group Q connected to the group(s) A by the group B.

According to any one of the embodiments of the invention, the modifying agent preferably contains just one group Q and just one group A connected to one another by the group B.

Dipole is understood to mean a functional group capable of forming a [1,3]-dipolar cycloaddition on an unsaturated carbon-carbon bond.

“Associative group” is understood to mean groups capable of associating with one another via hydrogen, ionic and/or hydrophobic bonds. According to a preferred form of the invention, they are groups capable of associating via hydrogen bonds. When the associative groups are capable of associating via hydrogen bonds, each associative group comprises at least one donor “site” and one site which is accepting with regard to the hydrogen bond, so that two identical associative groups are self-complementary and can associate together with the formation of at least two hydrogen bonds. The associative groups according to embodiments of the invention are also capable of associating via hydrogen, ionic and/or hydrophobic bonds with functional groups present on fillers.

According to a specific embodiment of the invention, the group A is selected from the group consisting of the imidazolidinyl, triazolyl, triazinyl, bis-ureyl and ureido-pyrimidyl groups.

According to a preferential embodiment of the invention, the group A corresponds to one of the formulae (I) to (V):

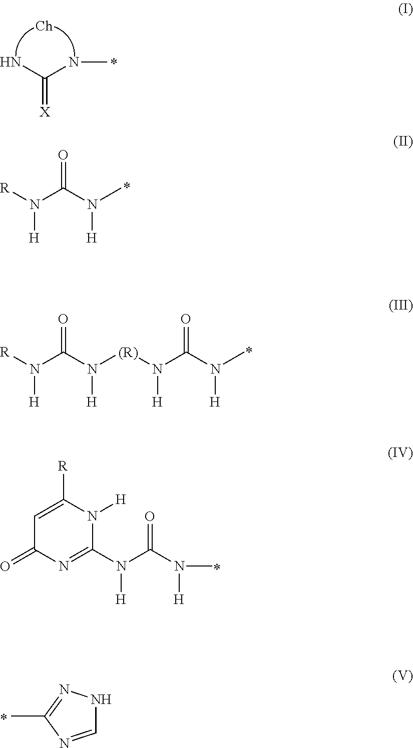

where:
Ch denotes a carbon chain which can optionally contain heteroatoms,
* represents a direct attachment to B,
R denotes a hydrocarbon group which can optionally contain heteroatoms,
X denotes an oxygen or sulphur atom, preferably an oxygen atom.

Generally, the ring in the formula (I) is a ring comprising 5 or 6 atoms.

According to a more preferential embodiment of the invention, the group A corresponds to the formula (VI):

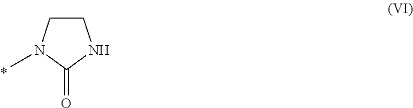

where * represents a direct attachment to B.

The group B, which is an atom or a group of atoms forming a bond between Q and A, is preferably a group containing up to 20 carbon atoms and can contain at least one heteroatom. B can be an aliphatic chain, preferentially containing from 1 to 20 carbon atoms, more preferentially from 1 to 12 carbon atoms and even more preferentially from 1 to 6 carbon atoms, or a group containing an aromatic subunit and preferentially containing from 6 to 20 carbon atoms, more preferentially from 6 to 12 carbon atoms.

According to a preferential embodiment of the invention, the modifying agent is a 1,3-dipolar compound selected from the group consisting of nitrile oxides, nitrones and nitrile imines, in which case Q contains a —C″Nfi O, —C═N(fi O)— or —C″Nfi N— subunit.

According to the specific embodiment of the invention in which Q comprises a —C″Nfi O subunit, Q preferentially denotes the subunit corresponding to the formula (VII) in which four of the five symbols R₄ to R₈, which are identical or different, are each an atom, in particular H, or a group of atoms and the fifth symbol denotes a direct attachment to B, it being known that R₄ and R₈ are both preferably different from H. The four of the five symbols R₄ to R₈ may be aliphatic or aromatic groups containing an (one or more) aromatic subunit. The aliphatic groups may contain from 1 to 20 carbon atoms, preferentially from 1 to 12 carbon atoms, more preferentially from 1 to 6 carbon atoms and more preferentially still from 1 to 3 carbon atoms. The groups containing an (one or more) aromatic subunit may contain 6 to 20 carbon atoms, preferentially 6 to 12 carbon atoms.

R₄, R₆ and R₈ are preferentially each an alkyl group of 1 to 6 carbon atoms, more preferentially of 1 to 3 carbon atoms and even more preferentially a methyl or ethyl group.

According to a variant of this specific embodiment of the invention, R₄, R₆ and R₈ are identical. According to this variant in which they are identical, R₄, R₆ and R₈ are preferentially each an alkyl group of 1 to 6 carbon atoms, more preferentially of 1 to 3 carbon atoms, and even more preferentially a methyl or ethyl group.

According to a preferential embodiment of this variant, the modifying agent is one of the 1,3-dipolar compounds of formula (VIII) to (XIII):

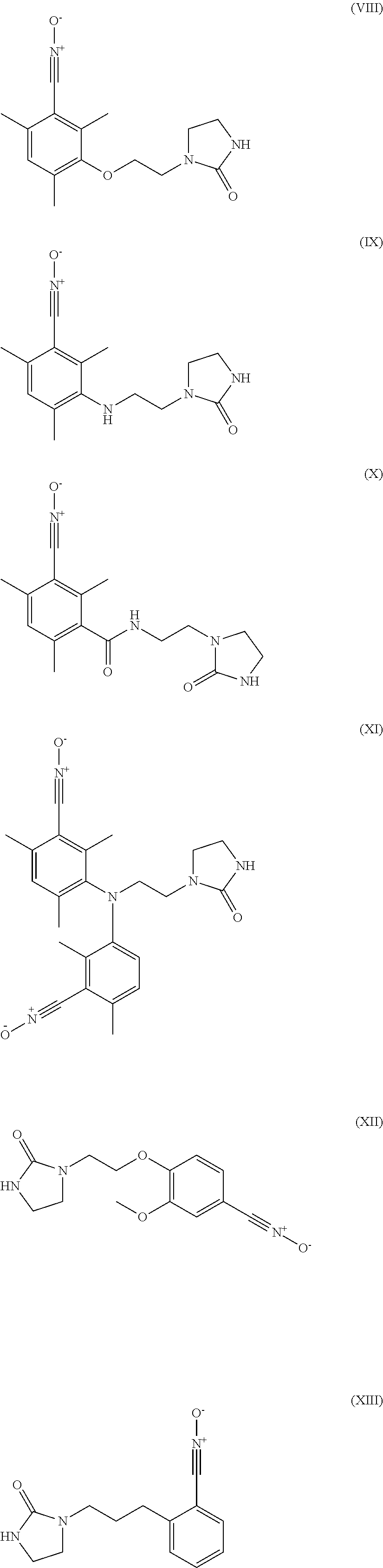

More preferably, the modifying agent is the 1,3-dipolar compound of formula (VIII), 2,4,6-trimethyl-3-(2-(2-oxoimidazolidin-1-yl)ethoxy)benzonitrile oxide.

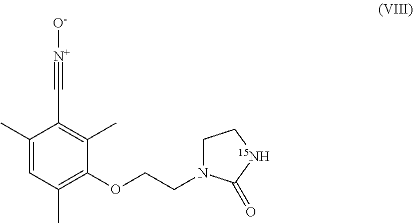 [SMILES: Cc1cc(C)c(OCCN2CC[15NH]C2=O)c(C)c1C#[N+][O-]]

According to the specific embodiment of the invention in which Q comprises a —C═N(fi O)— subunit, Q preferentially comprises the subunit corresponding to the formula (XIV) or (XV)

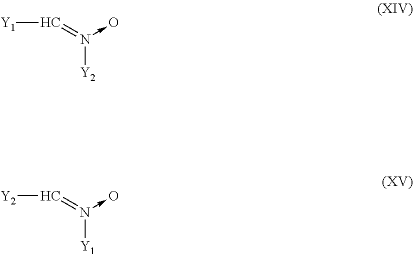

where:
Y₁ is an aliphatic group, preferentially an alkyl group preferably containing from 1 to 12 carbon atoms, or a group containing from 6 to 20 carbon atoms and comprising an aromatic subunit, preferentially an aryl or alkylaryl group, more preferentially a phenyl or tolyl group,
and Y₂ is an aliphatic group, preferentially a saturated hydrocarbon group, preferably containing from 1 to 12 carbon atoms, or a group comprising an aromatic subunit and preferentially containing from 6 to 20 carbon atoms, Y₂ comprising a direct attachment to B.

According to this specific embodiment of the invention, the modifying agent is one of the 1,3-dipolar compounds of formula (XVI) to (XX):

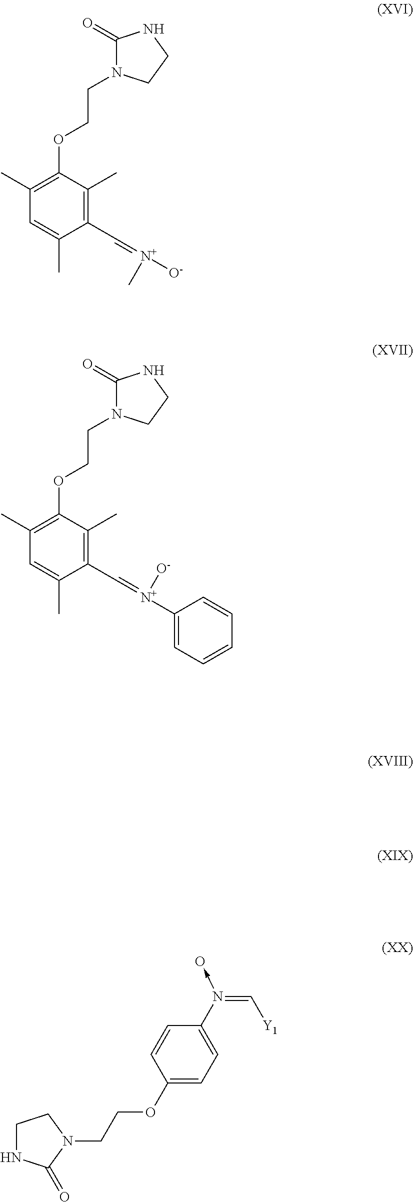

with Y₁ being as defined above, namely an aliphatic group, preferentially an alkyl group preferably containing from 1 to 12 carbon atoms, or a group containing from 6 to 20 carbon atoms and comprising an aromatic subunit, preferentially an aryl or alkylaryl group, more preferentially a phenyl or tolyl group.

The content of modifying agent used is expressed as molar equivalent of group A. For example, if the modifying agent contains just one group A such as, for example, in the 1,3-dipolar compound of formula (VIII), one mole of modifying agent corresponds to one mole of group A. If this modifying agent contains two rings of group A, one mole of modifying agent corresponds to two moles of group A. In the latter case, the use of the modifying agent according to a molar equivalent of group A corresponds to half a mole of modifying agent.

According to any one of the embodiments of the invention, the amount of modifying agent used is preferentially from 0.01 to 50, more preferentially from 0.01 to 10, even more preferentially from 0.03 to 5 and better still from 0.03 to 3 molar equivalents of group A per 100 mol of monomer units constituting the first diene elastomer.

The rubber composition in accordance with embodiments of the invention comprises any type of “reinforcing” filler known for its abilities to reinforce a rubber composition which can be used for the manufacture of tires, for example an organic filler, such as carbon black, a reinforcing inorganic filler, such as silica, with which is combined, in a known way, a coupling agent, or also a mixture of these two types of filler.

Such a reinforcing filler typically consists of nanoparticles, the (weight-)average size of which is less than a micrometre, generally less than 500 nm, usually between 20 and 200 nm, in particular and more preferentially between 20 and 150 nm.

All carbon blacks, especially the blacks conventionally used in tires or their treads (“tire-grade” blacks), are suitable as carbon blacks. Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks may be used on their own, as available commercially, or in any other form, for example as support for some of the rubber-making additives used.

“Reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferentially silica (SiO₂), are suitable in particular as reinforcing inorganic fillers. The silica used can be any reinforcing silica known to those skilled in the art, especially any precipitated or fumed silica having a BET surface area and a CTAB specific surface area both of less than 450 m²/g, preferably from 30 to 400 m²/g, especially between 60 and 300 m²/g. As highly dispersible precipitated silicas (“HDSs”), mention will be made, for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber and the silicas having a high specific surface area as described in application WO 03/016387.

In the present account, the BET specific surface area is determined in a known way by gas adsorption using the Brunauer-Emmett-Teller method described in The Journal of the American Chemical Society, Vol. 60, page 309, February 1938, more specifically, according to French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface area is the external surface area determined according to French Standard NF T 45-007 of November 1987 (method B).

The physical state in which the reinforcing inorganic filler is provided is unimportant, whether it is in the form of a powder, microbeads, granules or even beads. Of course, reinforcing inorganic filler is also understood to mean mixtures of different reinforcing inorganic fillers, in particular of highly dispersible silicas as described above.

Those skilled in the art will understand that use might be made, as filler equivalent to the reinforcing inorganic filler described in the present paragraph, of a reinforcing filler of another nature, especially organic, such as carbon black, provided that this reinforcing filler is covered with an inorganic layer, such as silica, or else comprises, at its surface, functional sites, especially hydroxyl sites, requiring the use of a coupling agent in order to establish the bond between the filler and the elastomer. Mention may be made, by way of example, for example, of carbon blacks for tires, such as described, for example, in patent documents WO 96/37547 and WO 99/28380.

According to a specific embodiment of the invention, the inorganic filler, preferentially a silica, represents more than 50% by weight of the reinforcing filler of the rubber composition. It is then said that the reinforcing inorganic filler is predominant.

When it is combined with a predominant reinforcing inorganic filler, such as silica, the carbon black is preferably used at a content of less than 20 phr, more preferentially of less than 10 phr (for example, between 0.5 and 20 phr, especially between 2 and 10 phr). Within the intervals indicated, the colouring properties (black pigmenting agent) and UV-stabilizing properties of the carbon blacks are beneficial, without, moreover, adversely affecting the typical performance properties contributed by the reinforcing inorganic filler.

According to another specific embodiment of the invention, the carbon black represents more than 50%, preferably 100% by weight of the reinforcing filler of the rubber composition.

The content of total reinforcing filler is preferentially between 20 and 200 phr. Below 20 phr, the reinforcement of the rubber composition can be insufficient to contribute an appropriate level of cohesion or wear resistance of the rubber component of the tire comprising this composition. Above 200 phr, there is a risk of increasing the hysteresis and thus the rolling resistance of the tires. For this reason, the content of total reinforcing filler is more preferentially between 30 and 150 phr, even more preferentially from 50 to 150 phr, especially for use in a tire tread. Any one of these ranges of content of total reinforcing filler may apply to any one of the embodiments of the invention.

In order to couple the reinforcing inorganic filler to the diene elastomer, use is made, in a well-known way, of an at least bifunctional coupling agent, especially a silane, (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is made especially of silane polysulphides, referred to as “symmetrical” or “asymmetrical” depending on their specific structure, such as described, for example, in applications WO 03/002648 (or US 2005/016651) and WO 03/002649 (or US 2005/016650).

Particularly suitable, without the definition below being limiting, are silane polysulphides corresponding to the general formula (V):

Z-G-Sₓ-G-Z (V)
in which:
   x is an integer from 2 to 8 (preferably from 2 to 5);
   the G symbols, which are identical or different, represent a divalent hydrocarbon radical (preferably a C₁-C₁₈ alkylene group or a C₆-C₁₂ arylene group, more particularly a C₁-C₁₀, especially C₁-C₄, alkylene, in particular propylene);
   the Z symbols, which are identical or different, correspond to one of the three formulae below:

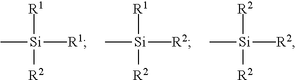

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, even more preferentially a group chosen from C₁-C₄ alkoxyls, in particular methoxyl and ethoxyl).

In the case of a mixture of alkoxysilane polysulphides corresponding to the above formula (I), especially customary commercially available mixtures, the mean value of “x” is a fractional number preferably of between 2 and 5, more preferentially close to 4. However, embodiments of the invention may also be advantageously carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂.

As coupling agent other than alkoxysilane polysulphide, mention will especially be made of bifunctional POSs (polyorganosiloxanes), or else of hydroxysilane polysulphides, such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

The content of coupling agent is advantageously less than 30 phr, it being understood that it is generally desirable to use as little as possible thereof. Typically, the content of coupling agent represents from 0.5% to 15% by weight, with respect to the amount of inorganic filler. Its content is preferentially between 0.5 and 16 phr, more preferentially within a range extending from 3 to 10 phr. This content is easily adjusted by those skilled in the art depending on the content of inorganic filler used in the composition.

The rubber composition in accordance with embodiments of the invention can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state.

Another component of the composition according to embodiments of the invention is the chemical crosslinking agent. The chemical crosslinking makes possible the formation of covalent bonds between the elastomer chains. The chemical crosslinking agent may be a vulcanization system or one or more peroxide compounds.

The vulcanization system per se is based on sulphur (or on a sulphur-donating agent) and on a primary vulcanization accelerator. Additional to this base vulcanization system are various known secondary vulcanization accelerators or vulcanization activators, such as zinc oxide, stearic acid or equivalent compounds, or guanidine derivatives (in particular diphenylguanidine), incorporated during the first non-productive phase and/or during the productive phase, as described subsequently. The sulphur is used at a preferential content of 0.5 to 12 phr, in particular of 1 to 10 phr. The primary vulcanization accelerator is used at a preferential content of between 0.5 and 10 phr, more preferentially of between 0.5 and 5 phr. Use may be made, as (primary or secondary) accelerator, of any compound capable of acting as accelerator for the vulcanization of diene elastomers in the presence of sulphur, especially accelerators of thiazole type, and also their derivatives, and accelerators of thiuram and zinc dithiocarbamate types. Preferably, use is made of a primary accelerator of the sulphenamide type.

When the chemical crosslinking is carried out using one or more peroxide compounds, the said peroxide compound or compounds represent from 0.01 to 10 phr. Mention may be made, as peroxide compounds which can be used as chemical crosslinking system, of acyl peroxides, for example benzoyl peroxide or p-chlorobenzoyl peroxide, ketone peroxides, for example methyl ethyl ketone peroxide, peroxyesters, for example t-butyl peroxyacetate, t-butyl peroxybenzoate and t-butyl peroxyphthalate, alkyl peroxides, for example dicumyl peroxide, di(t-butyl) peroxybenzoate and 1,3-bis(t-butylperoxyisopropyl)benzene, or hydroperoxides, for example t-butyl hydroperoxide.

The rubber composition in accordance with embodiments of the invention can also comprise all or a portion of the usual additives generally used in the elastomer compositions intended to constitute external mixtures of finished rubber articles, such as tires, in particular treads, such as, for example, plasticizers or extending oils, whether the latter are aromatic or non-aromatic in nature, especially very weakly aromatic or non-aromatic oils (e.g., paraffin oils, hydrogenated naphthenic oils, MES oils or TDAE oils), vegetable oils, in particular glycerol esters, such as glycerol trioleates, pigments, protection agents, such as antiozone waxes, chemical antiozonants or antioxidants, antifatigue agents, reinforcing resins (such as resorcinol or bismaleimide), methylene acceptors (for example phenolic novolak resin) or methylene donors (for example HMT or H3M), such as described, for example, in application WO 02/10269.

The rubber composition according to embodiments of the invention can be manufactured in appropriate mixers, using two successive preparation phases according to a general procedure well known to those skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the chemical crosslinking agent, in particular the vulcanization system, is incorporated.

Generally, all the base constituents of the composition included in the tire of embodiments of the invention, with the exception of the chemical crosslinking agent, namely the reinforcing filler and the coupling agent, if appropriate, are intimately incorporated, by kneading, into the first diene elastomer, and if appropriate into the second diene elastomer, during the first “non-productive” phase, that is to say that at least these various base constituents are introduced into the mixer and are thermomechanically kneaded, in one or more steps, until the maximum temperature of between 130° C. and 200° C., preferably of between 145° C. and 185° C., is reached.

By way of example, the first (non-productive) phase is carried out in a single thermomechanical step during which all the necessary constituents, the optional supplementary processing aids and various other additives, with the exception of the chemical crosslinking agent, are introduced into an appropriate mixer, such as an ordinary internal mixer. The total duration of the kneading, in this non-productive phase, is preferably between 1 and 15 min. After cooling the mixture thus obtained during the first non-productive phase, the chemical crosslinking agent is then incorporated at low temperature, generally in an external mixer, such as an open mill; everything is then mixed (productive phase) for a few minutes, for example between 2 and 15 min.

The final composition thus obtained is subsequently calendered, for example in the form of a sheet or slab, especially for laboratory characterization, or else extruded in the form of a rubber profiled element which can be used as semi-finished tire product for a vehicle.

Thus, according to a specific embodiment of the invention, the rubber composition in accordance with embodiments of the invention, which can either be in the uncured state (before crosslinking or vulcanization) or in the cured state (after crosslinking or vulcanization), is a semi-finished product which may be used in a tire, especially as a tire tread.

Another subject of the invention is the process for preparing the rubber composition described above.

The first diene elastomer is grafted by reacting said elastomer with the reactive group(s) borne by the modifying agent. During this reaction, this(these) reactive groups form covalent bonds with the elastomer chain. The modifying agent is grafted by [3+2] cycloaddition of the reactive group(s) of the modifying agent to one or more double bonds of the polymer chain. The reaction product of a nitrile oxide, of a nitrone and of a nitrile imine, for example with a 1,4-butadiene unit, can be illustrated by the following equations, in which the symbol [symbol] represents any substituent:
Cycloaddition of a nitrile oxide to a butadiene unit

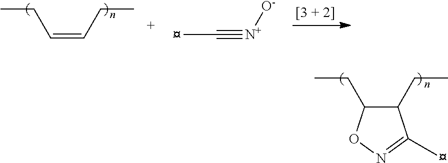

Cycloaddition of a nitrone to a butadiene unit

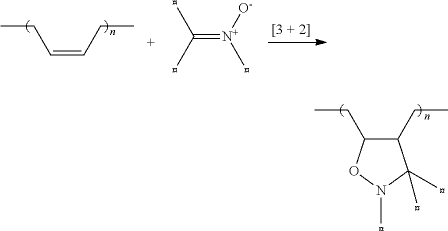

Cycloaddition of a nitrile imine to a butadiene unit

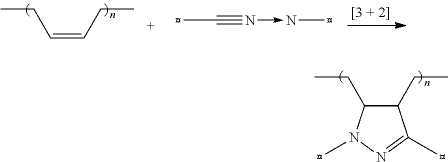

The modifying agent may be grafted in bulk, for example in an internal mixer or an external mixer, such as an open mill. The grafting is then carried out either at a temperature of the external mixer or of the internal mixture of less than 60° C., followed by a step of a grafting reaction under a press or in an oven at temperatures ranging from 80° C. to 200° C., or at a temperature of the external mixer or of the internal mixer of greater than 60° C., without subsequent heat treatment.

The grafting of the modifying agent may also be carried out in solution, continuously or batchwise. If the grafting takes place in solution, the grafted elastomer can be separated from its solution by any type of means known to those skilled in the art and in particular by a steam stripping operation.

According to a first embodiment of the invention, the first diene elastomer has been grafted by the modifying agent prior to the manufacture of the rubber composition. Thus, in this case, it is the first grafted diene elastomer which is introduced during the first “non-productive” phase. Thus, according to this first embodiment of the process, the latter comprises the following steps:
modifying the first diene elastomer in post-polymerization or in solution or in bulk by grafting the modifying agent defined according to any one of the embodiments of the invention,
Incorporating, to the first diene elastomer grafted in this way by the modifying agent, the reinforcing filler and all the base constituents of the composition, with the exception of the chemical crosslinking agent, by thermomechanically kneading everything, once or several times, until a maximum temperature of between 130° C. and 200° C., preferably between 145° C. and 185° C., is achieved,
cooling the combined mixture to a temperature of less than 100° C.,
then incorporating the chemical crosslinking agent,
kneading everything up to a maximum temperature of less than 120° C.

According to a second embodiment of the invention, the first diene elastomer is grafted by the modifying agent concomitantly to the manufacture of the rubber composition. In this case, both the as yet ungrafted first diene elastomer and the modifying agent are introduced during the first “non-productive” phase. The reinforcing filler is then preferentially added subsequently, during this same “non-productive” phase, so as to prevent any side reaction with the modifying agent. Thus, according to this second embodiment of the process, the latter comprises the following steps:
Incorporating, to the first diene elastomer, the modifying agent defined according to any one of the embodiments of the invention, and, preferably subsequently, the reinforcing filler and all the base constituents of the composition, with the exception of the chemical crosslinking agent, by thermomechanically kneading everything, once or several times, until a maximum temperature of between 130° C. and 200° C., preferably between 145° C. and 185° C., is achieved,
cooling the combined mixture to a temperature of less than 100° C.,
then incorporating the chemical crosslinking agent,
kneading everything up to a maximum temperature of less than 120° C.

According to this second embodiment of the invention, the incorporation of the first diene elastomer with the modifying agent is conducted at a temperature and for a time such that the grafting yield is preferably greater than 60%, more preferentially greater than 80%.

The abovementioned characteristics of embodiments of the present invention, and also others, will be better understood on reading the following description of several implementational examples of the invention, given by way of illustration and without limitation.

### II. IMPLEMENTATIONAL EXAMPLES OF THE INVENTION

II.1-Measurements and Tests Used:

Glass Transition Temperature

The glass transition temperatures, Tg, of the polymers are measured using a differential scanning calorimeter. The analysis is carried out according to the requirements of Standard ASTM D3418-08.

Size-Exclusion Chromatography

Size-exclusion chromatography (SEC) is used. SEC makes it possible to separate macromolecules in solution according to their size through columns filled with a porous gel. The macromolecules are separated according to their hydrodynamic volume, the bulkiest being eluted first. Without being an absolute method, SEC makes it possible to comprehend the distribution of the molar masses of a polymer. The various number-average molar masses (Mn) and weight-average molar masses (Mw) can be determined from commercial standards and the polydispersity index (PI=Mw/Mn) can be calculated via a “Moore” calibration.

Preparation of the polymer: There is no specific treatment of the polymer sample before analysis. The latter is simply dissolved, in tetrahydrofuran+1 vol % of diisopropylamine+1 vol % of triethylamine+1 vol % of distilled water or in chloroform, at a concentration of approximately 1 g/I. The solution is then filtered through a filter with a porosity of 0.45 μm before injection.

SEC analysis: The apparatus used is a Waters Alliance chromatograph. The elution solvent is tetrahydrofuran+1 vol % of diisopropylamine+1 vol % of triethylamine or chloroform, according to the solvent used for the dissolution of the polymer. The flow rate is 0.7 ml/min, the temperature of the system is 35° C. and the analytical time is 90 min. A set of four Waters columns in series, with commercial names Styragel HMW7, Styragel HMW6E and two Styragel HT6E, is used.

The volume of the solution of the polymer sample injected is 100 μl. The detector is a Waters 2410 differential refractometer and the software for making use of the chromatographic data is the Waters Empower system.

The calculated average molar masses are relative to a calibration curve produced from PSS Ready Cal-Kit commercial polystyrene standards.

Dynamic Properties

The dynamic properties G* and tan(d)max are measured on a viscosity analyser (Metravib VA4000) according to Standard ASTM D 5992-96. The response of a sample of vulcanized composition (cylindrical test specimen with a thickness of 4 mm and a cross-section of 400 mm²), subjected to a simple alternating sinusoidal shear stress, at a frequency of 10 Hz, under standard temperature conditions (23° C.) according to Standard ASTM D 1349-99, is recorded. A strain amplitude sweep is carried out from 0.1% to 100% (outward cycle) and then from 100% to 0.1% (return cycle). The results made use of are the complex dynamic shear modulus (G*) and the loss factor tan(d). For the return cycle, the maximum value of tan(d) observed, denoted tan(d)max, is indicated.

II.2-Preparation of the Rubber Compositions:

The elastomers E1 and E2 are used in the preparation of the rubber compositions C1 and C2. The elastomer E1 is a copolymer of 1,3-butadiene and of styrene, SBR, containing 26% by weight of styrene units and 24 mol % of 1,2-butadiene units of the butadiene part, with Mn=163 000 g/mol, with PI=1.15 and with Tg=−48° C.

The elastomer E2 is a copolymer of 1,3-butadiene and of ethylene comprising 66 mol % of ethylene units, the remainder to 100% consisting of the butadiene units distributed in the 1,2- (46.4 mol % of the butadiene units), 1,4- (31.8 mol % of the butadiene units) and 1,2-cyclohexyl- (21.8 mol % of the butadiene units) form, and has an Mn of 175 000 g/mol, a PI of 1.79 and a Tg of −43° C. The elastomer E2 is prepared according to a polymerization process in accordance with Example 4-2 described in patent EP 1 954 705 B1 on behalf of the Applicants.

The formulations (in phr) of the compositions C1 and C2 are described in Table I. The compositions are identical, apart from the nature of the elastomer. The composition C1 contains the elastomer E1 (the SBR) and the composition C2 contains the elastomer E2 (copolymer of 1,3-butadiene and of ethylene). The composition C2 is in accordance with embodiments of the invention, the composition C1 is a composition not in accordance with the invention and is a control composition for the composition C2.

The rubber compositions are prepared in the following way: the diene elastomer and the modifying agent are introduced into a Polylab internal mixer of 85 cm³ which is 70% filled and which has an initial vessel temperature of approximately 110° C. and thermomechanical working is carried out for 1 to 2 min. Then, the reinforcing filler, the coupling agent and then, after kneading for one to two minutes, the various other ingredients, with the exception of the vulcanization system, are introduced. Thermomechanical working is then carried out (non-productive phase) in one step (total duration of the kneading equal to approximately 5 min), until a maximum “dropping” temperature of 160° C. is reached. The mixture thus obtained is recovered and cooled and then the vulcanization system (sulphur) is added on an external mixer (homofinisher) at 25° C., everything being mixed (productive phase) for approximately 5 to 6 min.

The 1,3-dipolar compound, 2,4,6-trimethyl-3-(2-(2-oxoimidazolidin-1-yl)ethoxy)benzonitrile oxide, is used as modifying agent, the synthesis of which is described in the document WO 2012007442. For the compositions C1 and C2, the contents of modifying agent are respectively 1.40 phr and 2.40 phr, which in the two cases is equal to an identical molar content of modifying agent per 100 mol of elastomer monomer unit, i.e. 0.3 mol of modifying agent per 100 mol of monomer unit of the elastomer E1 and E2, respectively.

II.3-Properties of the Rubber Compositions in the Cured State:

The compositions after vulcanization are calendered, either in the form of slabs (with a thickness ranging from 2 to 3 mm) or thin sheets of rubber, for the measurement of their physical or mechanical properties, or in the form of profiled elements which can be used directly, after cutting and/or assembling to the desired dimensions, for example as semi-finished products for tires, in particular for treads. The results are given in Table II.

Composition C2 has both a high level of stiffness in the cured state and a very low level of hysteresis, in comparison with composition C1 not in accordance with the invention. The combined use of the elastomer E2 and of the modifying agent makes possible a decrease of 20% in tandₘₐₓ at 23° C., with respect to the combined use of E1 and of the same modifying agent, whereas the two elastomers E1 and E2 have the same Tg and whereas the modifying agent is used at the same molar content per 100 mol of elastomer monomer units in the compositions C1 and C2. This result is all the more noteworthy as this gain in hysteresis is also accompanied by an increase of 30% in the complex shear modulus G* at 23° C. at 50% strain. This compromise in properties of the rubber composition between the hysteresis and the stiffness in the cured state promises an improved compromise between the performances of rolling resistance and wear, especially for a tire tread.

TABLE I

| Composition | C1 | C2 |
|---|---|---|
| Elastomer E1 | 100 | — |
| Elastomer E2 | — | 100 |
| Carbon black (1) | 3.00 | 3.00 |
| Silica (2) | 90.00 | 90.00 |
| Silane (3) | 7.20 | 7.20 |
| Modifying agent (4) | 1.40 | 2.40 |
| DPG (5) | 1.60 | 1.60 |
| Plasticizer | 31.50 | 31.50 |
| Antiozone wax | 1.65 | 1.65 |
| Antioxidant | 2.00 | 2.00 |
| Stearic acid | 2.00 | 2.00 |
| ZnO | 2.00 | 2.00 |
| Sulphur | 1.30 | 1.30 |
| Accelerator | 2.00 | 2.00 |

(1) N330
(2) Silica, Zeosil 1165 MP, Rhodia in the form of microbeads
(3) TESPT (Si69, Degussa)
(4) 2,4,6-trimethyl-3-(2-(2-oxoimidazolidin-1-yl)ethoxy)benzonitrile oxide
(5) Diphenylguanidine (Perkacit DPG from Flexsys)

TABLE II

| Properties in the cured | | |
|---|---|---|
| state | C1 | C2 |
| G*_{(50%)} (MPa) | 100 | 130 |
| Tandₘₐₓ | 100 | 80 |

1. A rubber composition based on at least one first diene elastomer, a reinforcing filler, a chemical crosslinking agent, and a modifying agent, optionally already grafted to the first diene elastomer, the modifying agent comprising a group Q and a group A connected to one another by a group B in which:
Q comprises a dipole containing at least one nitrogen atom,
A comprises an associative group comprising at least one nitrogen atom,
B is an atom or a group of atoms forming a bond between Q and A,
the first diene elastomer before grafting the modifying agent comprises the following units UA, UB, UC and UD, which units UA, UB, UC and UD are randomly distributed within the first diene elastomer,
UA) —CH₂—CH₂— according to a molar percentage of m %
UB) according to a molar percentage of n %
UC) 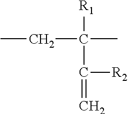
according to a molar percentage of o %
UD) 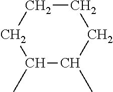
according to a molar percentage of p %
R₁ and R₂, which are identical or different, denoting a hydrogen atom, a methyl radical or a phenyl radical which is unsubstituted or substituted in the ortho, meta or para position by a methyl radical
m≧50
0<O+p≦25
n+o>0
m, n, o and p being numbers ranging from 0 to 100
the respective molar percentages of m, n, o and p being calculated on the basis of the sum of m+n+o+p, which is equal to 100.

2. A rubber composition according to claim 1, in which the first diene elastomer contains units UE randomly distributed within the first diene elastomer,
UE) 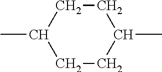
according to a molar percentage of q %
o+p+q≧10
q≧0
the respective molar percentages of m, n, o, p and q being calculated on the basis of the sum of m+n+o+p+q, which is equal to 100.

3. A rubber composition according to claim 1, in which the first diene elastomer contains units UF randomly distributed within the first diene elastomer,
UF) 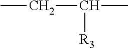
according to a molar percentage of r %
R₃ denoting an alkyl radical having from 1 to 4 carbon atoms or an aryl radical
0≦r≦25
the respective molar percentages of m, n, o, p, q and r being calculated on the basis of the sum of m+n+o+p+q+r, which is equal to 100.

4. A rubber composition according to claim 1, in which the first diene elastomer contains, as monomer units, only the units UA, UB, UC, UD and UE according to their respective molar percentage m, n, o, p and q.

5. A rubber composition according to claim 1, in which the first diene elastomer contains, as monomer units, only the units UA, UB, UC, and UD according to their respective molar percentage m, n, o, and p.

6. A rubber composition according to claim 1, in which R₁ and R₂ are identical and denote a hydrogen atom.

7. A rubber composition according to claim 1, in which the group A is selected from the group consisting of the imidazolidinyl, triazolyl, triazinyl, bis-ureyl and ureido-pyrimidyl groups.

8. A rubber composition according to claim 1, in which the group A corresponds to one of the following formulae (I) to (V): 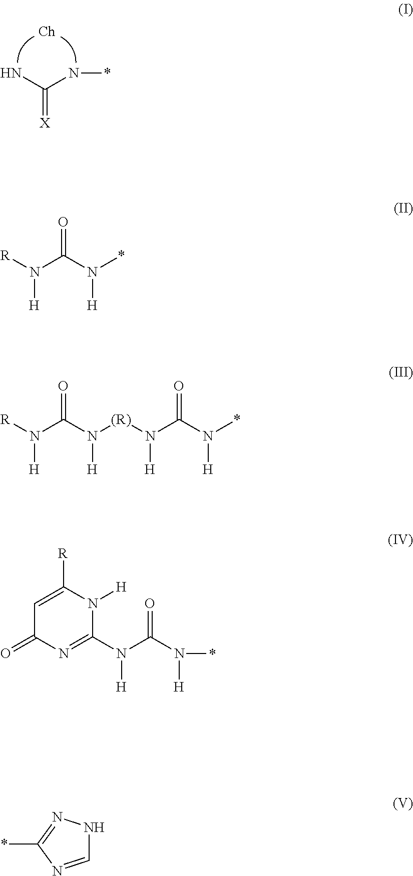
where:
Ch denotes a carbon chain which can optionally contain heteroatoms,
* represents a direct attachment to B,
R denotes a hydrocarbon group which can optionally contain heteroatoms,
X denotes an oxygen or sulphur atom.

9. A rubber composition according to claim 1, in which the group A corresponds to the formula (VI): 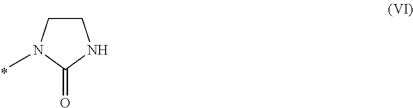
where * represents a direct attachment to B.

10. A rubber composition according to claim 1, in which B is a group containing up to 20 carbon atoms and can contain at least one heteroatom.

11. A rubber composition according to claim 10, in which B is an aliphatic chain or a group containing an aromatic subunit.

12. A rubber composition according to claim 1, in which the modifying agent is a 1,3-dipolar compound selected from the group consisting of nitrile oxides, nitrones and nitrile imines.

13. A rubber composition according to claim 1, in which Q contains a —C″Nfi O subunit.

14. A rubber composition according to claim 13, in which Q denotes the subunit corresponding to the formula (VII) 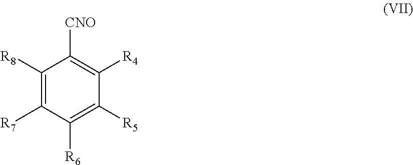
in which:
four of the five symbols R₄ to R₈, which are identical or different, are each an atom or a group of atoms, and the fifth symbol denotes a direct attachment to B.

15. A rubber composition according to claim 14, in which R₄, R₆ and R₈ are identical.

16. A rubber composition according to claim 14, in which R₄, R₆ and R₈ are each an alkyl group of 1 to 6 carbon atoms.

17. A rubber composition according to claim 16, in which R₄, R₆ and R₈ are each a methyl or ethyl.

18. A rubber composition according to claim 13, in which the modifying agent is one of the 1,3-dipolar compounds of formula (VIII) to (XIII):

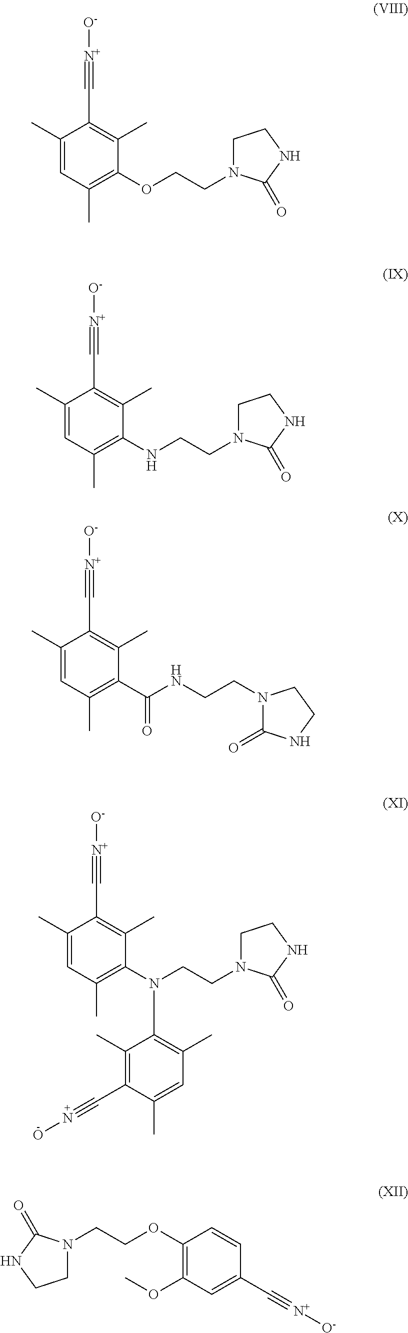

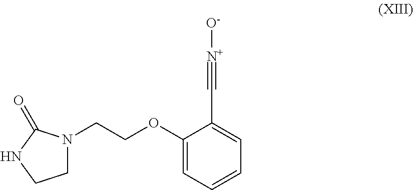 [SMILES: O=C1NCCN1CCOc1ccccc1C#[N+][O-]]

19. A rubber composition according to claim 1, in which Q contains the —C═N(fi O)— dipole.

20. A rubber composition according to claim 19, in which Q comprises the subunit corresponding to the formula (XIV) or (XV): 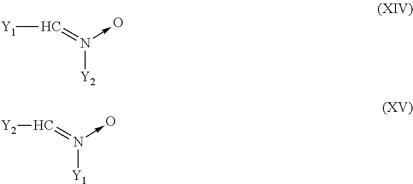
where
Y₁ is an aliphatic group, or a group containing from 6 to 20 carbon atoms and comprising an aromatic subunit,
and Y₂ is an aliphatic group, or a group comprising an aromatic subunit Y₂ comprising a direct attachment to B.

21. A rubber composition according to claim 19, in which the modifying agent is one of the 1,3-dipolar compounds of formula (XVI) to (XX): 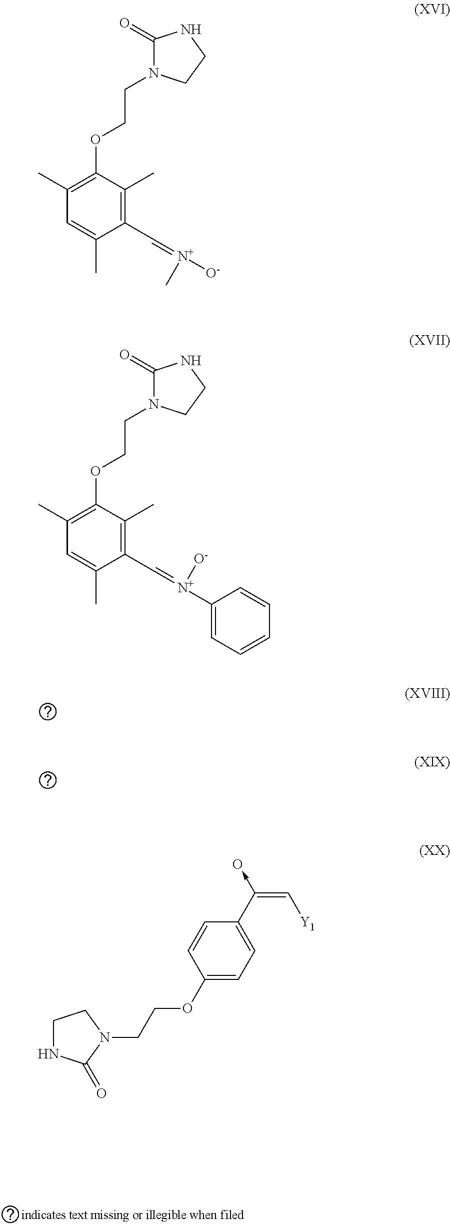
Y₁ being as defined in claim 19.

22. A rubber composition according to claim 1, in which the content of modifying agent varies from 0.01 to 50 molar equivalents.

23. A rubber composition according to claim 1, in which the chemical crosslinking agent comprises 0.5 to 12 phr of sulphur, or 0.01 to 10 phr of one or more peroxide compounds.

24. A rubber composition according to claim 1, in which the rubber composition comprises a second diene elastomer selected from the group consisting of polybutadienes, polyisoprenes, butadiene copolymers, isoprene copolymers and mixtures thereof.

25. A rubber composition according to claim 1, in which the rubber composition contains at least 50 phr of the first diene elastomer.

26. A rubber composition according to claimm 1, in which the reinforcing filler comprises a carbon black.

27. A rubber composition according to claim 1, in which the reinforcing filler comprises an inorganic filler.

28. A rubber composition according to claim 27, in which the reinforcing filler comprises a silica, which silica represents more than 50% by weight of the reinforcing filler.

29. A rubber composition according to claim 26, in which the carbon black represents more than 50% by weight of the reinforcing filler.

30. A process for preparing a rubber composition according to claim 1, which comprises the following steps:
modifying the first diene elastomer in post-polymerization or in solution or in bulk by grafting the modifying agent
incorporating, to the first diene elastomer grafted in this way by the modifying agent, the reinforcing filler and all the base constituents of the composition, with the exception of the chemical crosslinking agent, by thermomechanically kneading everything, once or several times, until a maximum temperature of between 130° C. and 200° C. is achieved,
cooling the combined mixture to a temperature of less than 100° C.,
then incorporating the chemical crosslinking agent,
kneading everything up to a maximum temperature of less than 120° C.

31. A process for preparing a rubber composition according to claim 1, which comprises the following steps:
incorporating, to the first diene elastomer, the modifying agent, the reinforcing filler and all the base constituents of the composition, with the exception of the chemical crosslinking agent, by thermomechanically kneading everything, once or several times, until a maximum temperature of between 130° C. and 200° C. is achieved,
cooling the combined mixture to a temperature of less than 100° C.,
then incorporating the chemical crosslinking agent,
kneading everything up to a maximum temperature of less than 120° C.

32. A semi-finished product made of rubber comprising a composition according to claim 1.

33. A semi-finished product according to claim 32, made of rubber, wherein the semi-finished product is a tire tread.

34. A tire that comprises a semi-finished product according to claim 32.
